(19) United States
(12) Patent Application Publication
(10) Pub. No.: US 2007/0229292 A1
(43) Pub. Date: Oct. 4, 2007

(54) Abnormal warning apparatus and detecting device for fluid circulating system

(76) Inventor: Qiang-Fei Duan, HuiZhou (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/724,161

(22) Filed: Mar. 15, 2007

(30) Foreign Application Priority Data
Mar. 17, 2006 (TW) 95204423

(51) Int. Cl. G08B 21/00

(52) U.S. Cl. 340/606

(57) ABSTRACT

An abnormal warning apparatus and detecting device that can be applied widely in a fluid circulating system is provided. The abnormal warning apparatus essentially includes a brightness tuning device, a light detecting unit, an analysis circuit, a light emitter, and an alarm. The ray of the light emitter penetrates through the tube having the brightness tuning device and enters the light detecting unit on the other side. After that, the various voltages transformed from the received ray with strong or week brightness or no light received are entered into the analysis circuit, then the voltages are determined to be normal or abnormal by comparing them with a standard voltage. The alarm goes off to warn with sound or light based on an output of abnormal voltage if the flow stops or becomes insufficient.

### BACKGROUND OF THE INVENTION

1. Field of the Invention

The present invention relates to a fluid circulating system, and more particularly to an abnormal warning apparatus and a detecting device for the fluid circulating system that can detect the circulating condition by means of light.

2. Description of Related Art

A prior art warning apparatus applied to a fluid circulating system is always installed between the flow paths, and operates the direct-contact detection. Usually, the current meter used to detect the flow rate was a drawback due to its large size. Further, the sensing element therein needs to contact the liquid in the tube directly, so it suffers problems of leakage and/or chemical change. With progressive manufacture technologies for every kind of photoelectric microelectronic products, such as a CPU being applied to the high-speed operating system, the increasingly high-speed operation has caused higher working temperatures that have serious effect on the devices and can even destroy the whole device or system. Therefore, in view of the current development of technologies, heat-dissipation is required under high-temperature conditions. In other words, a suitable heat-dissipation apparatus is imminently required to be applied to the high-speed operating system.

A warning apparatus used for a fluid circulating system was disclosed in TW Patent No. M273185. This warning apparatus was able to detect whether water was in the transparent or translucent tube or not by means of light. However, the conventionally provided warning apparatus merely sounds an alarm when the tube has no water, but is unable to detect whether the fluid is circulating normally or not. Nevertheless, the ability to detect whether the fluid is circulating normally is a basic issue of normal operation in a heat-dissipation system. Therefore a new detecting apparatus is requisite to assure the fluid in the circulating system is operating normally for providing a more precise detection.

### SUMMARY OF THE DISCLOSURE

Broadly speaking, the object of the present invention is to provide a detecting device for a fluid circulating system. This detecting device is used to detect whether the liquid flowing along a channel in the fluid circulating system is normal or not. By means of the detection, any abnormal condition can be found in time and solved as fast as possible.

Another object of the present invention is to provide a warning apparatus for the fluid circulating system. By means of momentary detection, the warning apparatus can be activated by an abnormal signal transmitted from an analysis circuit if the liquid flowing in the channel of the fluid circulating system is found to be circulating abnormally. Therefore the abnormal condition can be solved instantly.

A further object of the present invention is to provide a cold-water heat-dissipation system. This heat-dissipation system is applied to a heat source or any device in need of heat dissipation, whereby the temperature can be decreased to assure that the device operates continuously and smoothly. The detecting device of the present invention includes a brightness tuning device, a light detecting unit, and an analysis circuit. The brightness tuning device is disposed in a channel of the circulating system and therefore moves in response to the flow rate. After that, the brightness tuning device changes the path of light projected on it. Further, the light detecting unit is disposed on one side of the channel, and outputs a corresponding electronic signal according to the brightness of light emitting into the light detecting unit through the channel. Further, the analysis circuit is coupled to the light detecting unit for receiving the electronic signal, and determining the flow condition based on the signal.

In one of the preferred embodiments of the present invention, the brightness tuning device includes an opaque part which is used to block the incidental light from the light detecting unit as a default. Further, the channel is preferably arranged in non-horizontal direction, so the brightness tuning device can simply move in the channel under the effect of its own weight.

The warning apparatus of the fluid circulating system is further provided. The apparatus includes a detecting device and an alarm. The detecting device has a brightness tuning device, a light detecting unit, and an analysis circuit. The brightness tuning device is disposed in the channel, so it moves in response to the flow rate, and can change the path of light projected on it. Further, the light detecting unit is disposed on one side of the channel, and outputs a corresponding electronic signal according to the brightness of light emitting into the light detecting unit through the channel. Further, the analysis circuit is coupled to the light detecting unit for receiving electronic signals, and determining the flow condition based on the signal. Further still, the alarm couples with the analysis circuit for receiving the determination result from the analysis circuit, and detects the abnormal condition in response to the determination result, and decides whether to sound an alarm or not.

Since the alarm signal of the mentioned embodiment can be either sound or light, the safety of the circulating system is improved.

A water-cooled heat-dissipation system is provided, wherein the system has a cold-water circulating path for water circulation, and a detecting device disposed on a position of the cold-water circulating path. The detecting device has a brightness tuning device disposed in a channel on the position of the cold-water circulating path, and the position is determined due to the flow rate. Therefore, the brightness tuning device can change the following path of light projected on it, and the opaque part included in the device is pushed out of or into the detecting range of the light detecting unit by the liquid when the liquid flows normally. A light detecting unit is disposed on one side of the position and outputs a corresponding electronic signal according to the brightness of light emitting into the light detecting unit through the channel at the mentioned position of the cold-water circulating path. An analysis circuit is coupled to the light detecting unit for receiving the electronic signals, and outputting the corresponding determination result by determining the flow condition due to the electronic signals.

A design is provided in the present invention, which includes a brightness tuning device, a light detecting unit, an analysis circuit, a light emitter and an alarm. The light produced by the light emitter passes through the channel of the light detecting unit to the other side, and, importantly, the brightness tuning device is disposed in the channel. Next, the analysis circuit determines whether the liquid in the fluid circulating system is flowing normally or not, thereby the determination is made to sound the alarm or not. Therefore, the efficiency of using the device and the system safety can be improved since the alarm will be enabled in a timely manner whenever an abnormality occurs, especially when the fluid stops circulating or the circulating fluid is insufficient.

Since the brightness tuning device is introduced into the cycling circuit of the fluid circulating system, the brightness of the received light will be obviously affected. Afterward, the light detecting unit and the analysis circuit can be detected more precisely if there is an abnormal condition. Further, the system safety and its convenience can be improved remarkably. Furthermore, since the structure of the present invention is easy to make and has very low cost, it can spread its application to other photoelectric devices in need of heat dissipation.

### BRIEF DESCRIPTION OF DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of the fluid circulating system and the abnormal warning apparatus of the present invention;

FIG. 2 shows the schematic diagram of the transparent pipe of the abnormal warning apparatus of the present invention;

FIG. 3 shows the schematic diagram of the circuit board of the abnormal warning apparatus of the present invention;

FIG. 4 shows a fabricated diagram of the abnormal warning apparatus of the present invention;

FIG. 5 shows the circuitry of the abnormal warning apparatus of the present invention;

FIG. 6 shows a diagram of the round transparent pipe of the present invention;

FIG. 7 is a schematic diagram of the fluid circulating system in the normal state;

FIG. 8 is a schematic diagram of the fluid circulating system in the abnormal state;

FIG. 9 is a schematic diagram of the fluid circulating system in the normal state of another embodiment;

FIG. 10 is a schematic diagram of the fluid circulating system in the abnormal state of another embodiment.

### DETAILED DESCRIPTION OF THE PREFERRED EMBODIMENTS

For further understanding of the invention, please refer to the following detailed description illustrating the embodiments and examples of the invention. The description is only for illustrating the invention and is not intended to be considered limiting the scope of the claim.

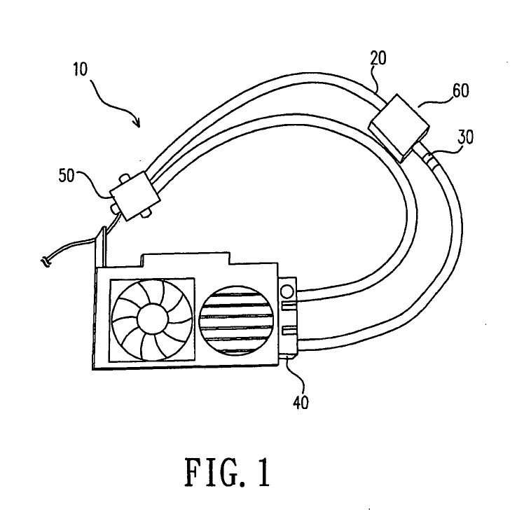

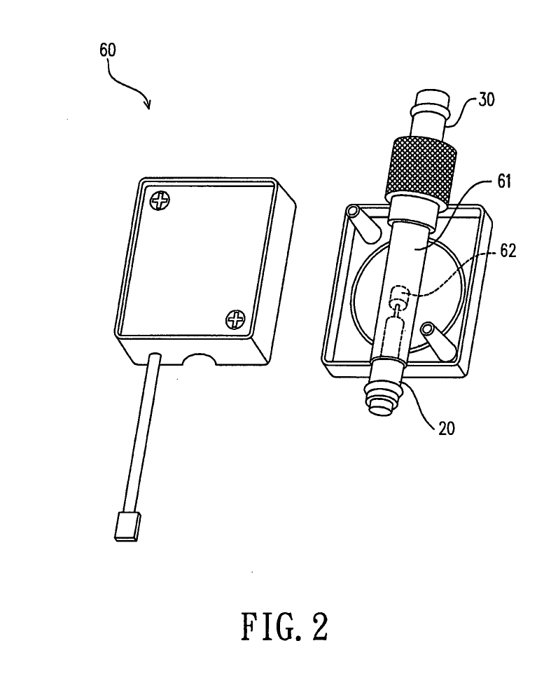

Reference is made to FIG. 1, which shows the abnormal warning apparatus and its detecting device for the fluid circulating system. The abnormal warning apparatus 60 is provided in the fluid circulating system 10 of the present invention. The pipes 20 and 30 at two ends of the apparatus 60 are fabricated with the water-cooling grate and its water-cooling header 50 (the pump can be integrated into the header) in series in the fluid circulating system 10. Referring to FIGS. 1 and 2, the abnormal warning apparatus 60 incorporates a channel 61 (preferably made of completely transparent pipe, but can also be made of partially transparent material), the two ends of the channel 61 respectively connect with the pipes 20 and 30, so the water-cooling fluid can pass through. A brightness tuning device 62 is disposed in the channel 61, and the device 62 further includes a light stopper. In the present embodiment, the light stopper is an opaque part of the brightness tuning device 62, but it is sufficient to change whether the light projected on the device 62 passes through the channel 61 or not.

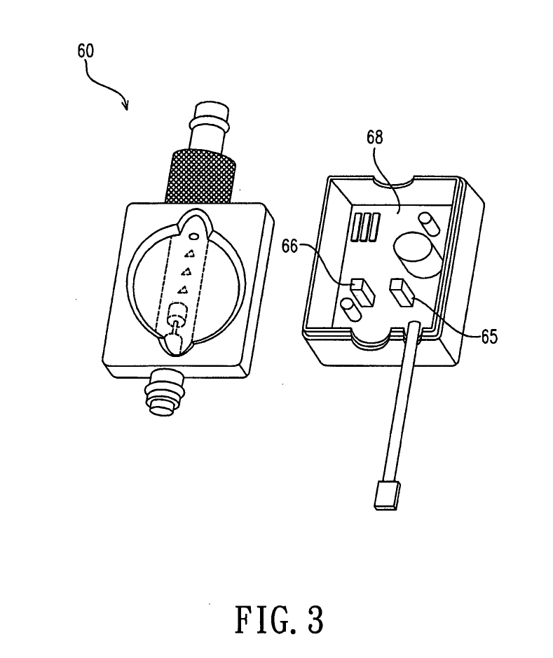

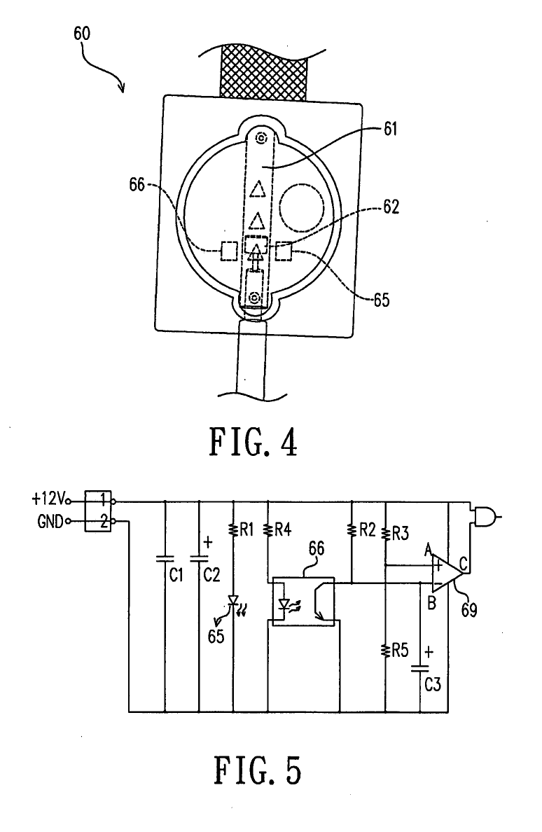

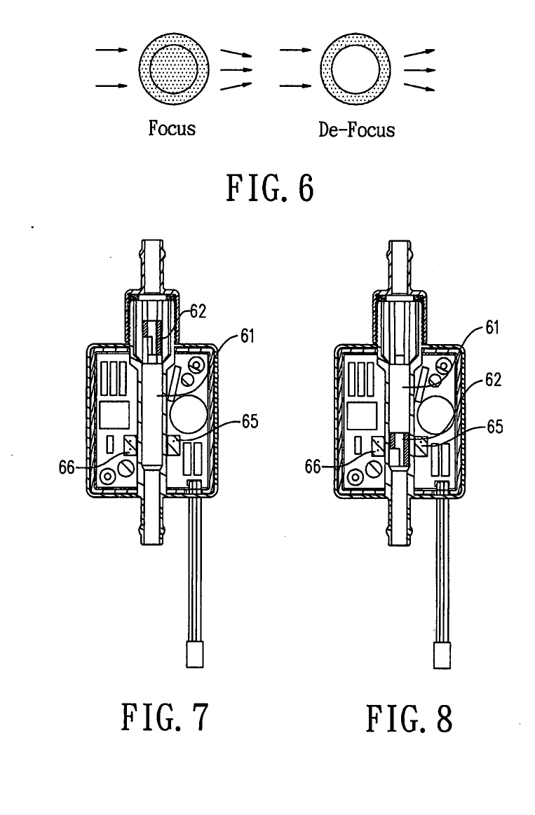

Furthermore, the channel 61 is disposed in a non-horizontal direction, so the brightness tuning device 62 moves in the channel 61 under the effect of its own weight. Reference is made to FIG. 3 showing a circuit board 68 disposed under the channel 61. The circuit board 68 includes a light emitter 65 (the light emitter can be an LED, an organic electroluminescent diode, a polymeric electroluminescent diode, a resonant cavity LED, a laser diode, or a vertical cavity surface emitting laser, etc.), a light detecting unit 66 and its corresponding analysis circuit. After fabricating the abnormal warning apparatus and the detecting device for the fluid circulating system (fabricated into a box as referred to in FIG. 4), the light emitter 65 and the light detecting unit 66 are disposed on a left side and a right side of the channel 61 respectively. The brightness tuning device 62 is in the transparent channel 61, wherein the light emitter 65 and the light detecting unit 66 are on different sides to provide the light emitting into the light detecting unit 66. The detailed circuitry thereof is shown in FIG. 6.

Please refer to both FIG. 4 and FIG. 5. FIG. 5 shows the circuitry of the embodiment of the abnormal warning apparatus. The light emitter 65 of the circuit board 68 and the light detecting unit 66 are disposed on two sides of the channel 61. The light from the light emitter 65 emits on one side of the channel 61, and passes through the channel 61 filled with liquid. The light is emitted into the light detecting unit 66 on the other side of the channel 61 after refraction, and then the light detecting unit 66 transforms the received light into different voltages according to the intensity of the received light. Next, the voltages are transmitted to the end B of the analysis circuit 69, and a comparison operation is processed between the transmitted voltages and a predetermined standard voltage at end A.

In the present embodiment, the greater the intensity of the light received by the light detecting unit 66, the lower the voltage is transformed. Conversely, the lesser the intensity of the light received by the light detecting unit 66, the higher the voltage is transformed. If the voltage at end B is lower than the voltage at end A, the situation is normal, and the alarm is disabled since the analysis circuit 69 is outputting a high voltage level. However, if the voltage at end B is higher than end A, the intensity of light received by the light detecting unit 66 is lower, that is, the light detecting unit 66 blocks the light and the situation is abnormal. In the meantime, the output end C of the analysis circuit 69 is at a low voltage level and the alarm is enabled to send out a warning to users.

The inside of the mentioned channel 61 has a circular shape as shown in FIG. 6. When cold water fills the channel 61, a convex-lens effect is formed to focus the light so that the light received by the light detecting unit 66 is stronger, for example the voltage at end B will be lower than 8.2 volt. Alternatively, when the channel 61 is empty or not full, no convex-lens effect occurs (de-focus), so the received light is weaker, for example, the voltage at end B will be higher than 9.3 volts.

The brightness tuning device 62 is disposed in the channel 61 and the specific gravity of the material of the device 62 is greater than 1.0. Reference is made to FIG. 7, when the water-cooling liquid is flowing normally, the flow acts on the upper and lower ends of the brightness tuning device 62 to form a pressure difference therebetween. Further, since the buoyant force of the brightness tuning device 62 is greater than its own weight, the device 62 moves up and is pushed away from the upper wider action region of the light emitter 65 and light detecting unit 66. In the meanwhile, the channel 61 is filled with liquid, so the light detecting unit 66 can receive a stronger signal and is in a normal state, for example, the voltage at end B will be higher than 8.2 volts.

Please refer to FIG. 8 in which the flow of the fluid circulating system 10 is stopped due to a failure of the pump or the pipe becomes blocked. In this instance the brightness tuning device 62 moves down to the action region of the light emitter 65 and the light detecting unit 66 since the device 62 loses the fluid action. After that, the device 62 will block the light, and the received light becomes very weak, for example, the voltage at end B will be greater than 9.8 volts.

To sum up the above embodiments and from the circuitry analysis, a standard voltage A is about 9.2 volt. If there is no liquid in the channel or the liquid therein does not flow, the light received by the light detecting unit 66 is weaker (the voltage at end B will be greater than 9.3 volts), the analysis circuit 69 declares that both states are abnormal, and the output end C will be at a low voltage level and sound the alarm.

FIGS. 7 and 8 show the embodiments of the present invention. In particular, the channel 61 includes a narrow section and a wide section. The channel 61 is disposed in a non-horizontal direction so that the narrow section is positioned under the wide section. This embodiment shows the inner diameter of the narrow section is similar to the size of the brightness tuning device 62. Further, the light emitter 65 and light detecting unit 66 are positioned under the wide section, that is also the narrow section of channel 61. When the liquid flows normally, the brightness tuning device 62 is pushed away from the action region of the light emitter 65 and the light detecting unit 66, and moves to the upper wide section. A normal state is shown in FIG. 7.

Alternatively, when the flow is insufficient or stops, the brightness tuning device 62, under its own weight, moves down to the action region of the light emitter 65 and the light detecting unit 66, the device 62 blocks the light and sends out the abnormal warning.

The present invention discloses an apparatus and a method for measuring the IC temperature employing a simple logical gate circuit to acquire an operating clock, and further determines the rate-type of the operating clock and the temperature difference. Moreover, an alarming method for a measurement system and a method for predicting an operating voltage are also achieved without any complicated circuit design.

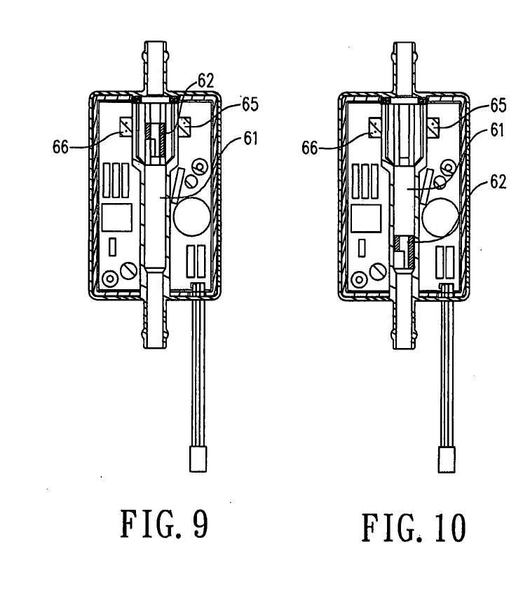

In the abnormal warning apparatus and the detecting device of another embodiment of the present invention, the light emitter 65 and the light detecting unit 66 are positioned above, that is the upper wide section of the channel 61 as shown in FIGS. 9 and 10. In particular, the inner diameter of the wide section is greater than the size of the brightness tuning device 62. When the liquid flows normally, the brightness tuning device 62 moves up to the upper wide section, and enters the action region of the light emitter 65 and the light detecting unit 66, being a normal state as is shown in FIG. 9. When the flow is insufficient or stops, the brightness tuning device 62 moves down and is pushed away from the action region of the light emitter 65 and the light detecting unit 66, being in an abnormal state as shown in FIG. 10.

The apparatus of the present invention includes the brightness tuning device, the light detecting unit, the analysis circuit, the light emitter and the alarm. More particularly the structure of the brightness tuning device is disposed in the channel of the circulating system. The brightness tuning device reacts to the intensity of emitted light, so whether the fluid circulating system is operating normally or abnormally can be precisely detected.

The many features and advantages of the present invention are apparent from the written description above and it is intended by the appended claims to cover all. Furthermore, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. An detecting device used in a fluid circulating system having liquid which is designed to flow along a channel, wherein the detecting device includes:
a brightness tuning device disposed in the channel, and moving in response to the flow rate, so that the brightness tuning device changes a path of light projected on it;
a light detecting unit disposed on one side of the channel, and outputting a corresponding electronic signal in response to the brightness of the light emitting into the light detecting unit through the channel; and
an analysis circuit coupled to the light detecting unit for receiving the electronic signal, and determining a flow condition of the liquid based on the electronic signal.

2. The detecting device according to claim 1, wherein the brightness tuning device includes a light stopper which changes depending upon whether a projecting light passes or not; and the light detecting unit outputs the corresponding electronic signal based on whether the light enters the light detecting unit through the channel or not.

3. The detecting device according to claim 1, wherein the brightness tuning device includes an opaque part.

4. The detecting device according to claim 3, wherein the opaque part of the brightness tuning device is pushed out of a detecting range of the light detecting unit when the liquid flows normally.

5. The detecting device according to claim 3, wherein the opaque part of the brightness tuning device is pushed into a detecting range of the light detecting unit when the liquid flows normally.

6. The detecting device according to claim 1, wherein the channel is arranged in a non-horizontal direction, so that the brightness tuning device moves in the channel only under the affect of its own weight.

7. The detecting device according to claim 1, wherein the channel has a narrow section and a wide section, an inner diameter of the narrow section is about the size of the brightness tuning device, and an inner diameter of the wide section is bigger than the size of the brightness tuning device.

8. The detecting device according to claim 7, wherein the channel is arranged in the non-horizontal direction, so that the narrow section is under the wide section.

9. The detecting device according to claim 8, wherein the light detecting unit is disposed in the narrow section.

10. The detecting device according to claim 8, wherein the light detecting unit is disposed in the wide section.

11. The detecting device according to claim 1, further including:
a light emitter disposed on a different side of the channel from the light detecting unit for providing the light emitted into the light detecting unit.

12. The detecting device according to claim 11, wherein the light emitter is an LED, an organic electroluminescent diode, a polymeric electroluminescent diode, a resonant cavity LED, a laser diode or a vertical cavity surface emitting laser.

13. The detecting device according to claim 1, wherein the detecting device is fabricated into a box.

14. The detecting device according to claim 1, wherein the detecting device is disposed on a specific position in the channel.

15. The detecting device according to claim 1, wherein the channel is a cold water circulating path for heat dissipation.

16. The detecting device according to claim 15, wherein the detecting device is disposed on a specific position along the cold water circulating path.

17. An alarm device, which is used for a fluid circulating system and a liquid therein flows along a channel, the alarm device comprising:
a brightness tuning device disposed on the channel, and moving in response to a flow rate, the brightness tuning device changes a path of light projected on it;
a light detecting unit disposed on one side of the channel, and outputting corresponding electronic signals in response to a brightness of light emitting into the light detecting unit through the channel;
an analysis circuit coupled to the light detecting unit for receiving the electronic signals, and determining the flow condition of the liquid based on the electronic signal, so as to output a corresponding analysis result; and
an alarm coupled to the analysis circuit for receiving the result outputted from the circuit, and determining if the alarm should be sounded based on the result.

18. The alarm device according to claim 17, wherein the brightness tuning device includes a light stopper, which changes depending upon whether a projecting light passes or not, and the light detecting device outputs the corresponding electronic signal in response to whether the light emitting into the light detecting unit via the channel or not.

19. The alarm device according to claim 17, wherein the brightness tuning device includes an opaque part, which is pushed out of or into a detecting range of the light detecting unit by the liquid when the liquid flows normally.

20. The alarm device according to claim 17, further including:
a light emitter disposed on a different side of the channel from the light detecting unit, so as to provide the light emitting into the light detecting unit;
wherein the light emitter is a light-emitting diode, an organic electroluminescent diode, a polymeric electroluminescent diode, a resonant cavity LED, a laser diode, or a vertical cavity surface emitting laser.

21. The alarm device according to claim 17, wherein the alarm device is fabricated into a box.

22. The alarm device according to claim 17, wherein the alarm includes a sounding device producing a warning sound or beep.

23. The alarm device according to claim 17, wherein the alarm device includes LEDs
